(19) United States
(12) Patent Application Publication
(10) Pub. No.: US 2025/0074037 A1
(43) Pub. Date: Mar. 6, 2025

(54) POLYAMIDE AND POLYOLEFIN CONTAINING ORIENTED FILMS

(71) Applicant: Winpak Ltd., Winnipeg (CA)

(72) Inventors: Mustafa Bilgen, Fayettville, GA (US); Olivier Yves Muggli, Winnipeg (CA)

(73) Assignee: Winpak Ltd., Winnipeg (CA)

(21) Appl. No.: 18/457,579

(22) Filed: Aug. 29, 2023

(51) Int. Cl. B32B 27/08; B32B 27/30; B32B 27/32; B32B 27/34

(52) U.S. Cl. CPC B32B 27/08; B32B 27/306; B32B 27/32; B32B 27/34; B32B 2250/05; B32B 2250/24; B32B 2307/306; B32B 2307/516; B32B 2307/518; B32B 2307/7244; B32B 2307/7376; B32B 2553/00

(57) ABSTRACT

An oriented film having a combination of polyolefin and polyamide layers. The film is low shrink and can be monoaxially or biaxially oriented. The polyolefin layer is positioned between two polyamide layers. A tie resin layer may be included between the polyolefin layer and either or both of the polyamide layers. A barrier layer, such as one formed from ethylene vinyl alcohol, may be positioned inside of the polyamide layers. The polyolefin layer may additionally incorporate a polyamide. The overall composition of the oriented film is selected so that the polyamide content is minimized enough that the film may be recycled in current polyethylene recycling streams.

### FIELD OF THE DISCLOSURE

The present disclosure relates to packaging films and, more specifically, to oriented films having polyolefin and polyamide layers for improved characteristics.

### BACKGROUND

The packaging industry currently produces oriented polyamide films without discrete polyolefin layers or polyolefin content. Similarly, the industry also produces oriented polyolefin films (e.g., polyethylene or polypropylene) but without discrete polyamide layers or polyamide content. For example, some polyamide-containing films used for packaging end uses (especially food packaging), use polyamide-containing heat-shrinkable films to form shrinkable bags (and patch bags), pouches, lidstock, and retortable and ovenable shrink packaging. Shrinkable films are not, however, ideal for lamination applications due to poor dimensional stability. Other approaches to packaging films include semi-crystalline polyamides selected from the group of polyamide 6, polyamide 66, polyamide 6/66, and polyamide 6/12. Once again, films such as these are shrinkable and thus not ideal for lamination applications due to poor dimensional stability. Attempts to provide films with more dimensional stability, more heat resistance, such as those using polyolefin, require the use of polyamides as an outer barrier layer or otherwise lack the use of a polyamide. Accordingly, there is a need in the art for an oriented packaging film that can provide new benefits such as better recyclability, higher heat resistance, and improved film properties such as modules, puncture strength or tensile strength.

### SUMMARY OF THE DISCLOSURE

The present disclosure provides oriented films having polyolefin and polyamide layers for improved characteristics. The oriented films are low shrink and combine polyolefin and polyamide layers in a single structure. For example, one aspect may have a polyolefin layer positioned immediately between a first polyamide layer and a second polyamide layer. Another aspect may comprise a polyolefin layer between a first polyamide layer and a second polyamide layer with a first tie resin layer and a second tie resin layer coupled between the polyolefin layer and the first polyamide layer and the second polyamide layer. A further aspect may include a combined polyolefin and polyamide layer between a first polyamide layer and a second polyamide layer. In any aspect, the polyolefin layer and polyamide layers may include a compatibilizer and a barrier layer positioned between the third layer and at least one of the first layer and the second layer or both the first layer and the second layer. The first polyamide and the second polyamide may comprise fifty percent or less of the oriented packaging film by volume. The first polyamide and the second polyamide may each be present in an amount of between one percent and 50 percent of the oriented packaging film by volume with the polyolefin present in an amount between 1 and 90 percent of the oriented packaging film by volume. The first polyamide and the second polyamide may also each be present in an amount of between 5 percent and 20 percent of the oriented packaging film by volume and the polyolefin is present in an amount between 10 and 80 percent of the oriented packaging film by volume. The oriented film may be oriented monoaxially or biaxially. The oriented packaging film may be recyclable in a polyethylene recycling stream. The present disclosure also provides methods of making packaging films that include coextruding a first layer comprised of a first polyamide, a second layer comprised of a second polyamide, and a third layer comprised of a polyolefin so that the third layer is positioned between the first layer and the second layer. The step of coextruding may include extruding a barrier layer positioned between the third layer and at least one of the first layer and the second layer, where the barrier layer may be formed from ethylene vinyl alcohol. The step of coextruding may also include extruding a first tie resin layer positioned between the third layer and one of the first layer and the second layer and/or extruding a second tie resin layer positioned between the third layer and the other of the first layer and the second layer.

### BRIEF DESCRIPTION OF THE DRAWINGS

The present invention will be more fully understood and appreciated by reading the following Detailed Description in conjunction with the accompanying drawings, in which:

FIG. 1 is a diagram of an embodiment of a film according to aspects of the present disclosure.

FIG. 2 is a diagram of another embodiment of a film according to aspects of the present disclosure.

FIG. 3 is a diagram of a further embodiment of a film according to aspects of the present disclosure.

### DETAILED DESCRIPTION OF EMBODIMENTS

As mentioned above, the packaging industry currently produces oriented polyamide films without discrete polyolefin layers or polyolefin content and also produces oriented polyolefin films (e.g., polyethylene or polypropylene) but without discrete polyamide layers or polyamide content. As described herein, it has been advantageously found that an oriented film that includes a combination of polyamide layers and polyolefin layers exhibits mechanical, chemical, and/or optical properties that provide numerous advantages such as better recyclability, higher heat resistance, as well as improved film properties such as modules, puncture strength and tensile strength. More specifically, the embodiments of the film allows for better recycling versus a traditional oriented polyamide film. The embodiments of the film also provide higher heat resistance versus an oriented polyethylene or polypropylene film. The embodiments of the film further enable better dimensional stability versus an oriented shrink film. For these reasons, the embodiments of the film are also a better lamination partner to form composite structures while keeping recyclability and dimensional stability. The embodiments of the film are designed to provide low shrink properties and thus have better dimensional stability and enables laminates having improved dimensional properties upon exposure to heat.

The term “polyamide” refers to a macromolecule containing a plurality of amide groups, i.e., groups of the formula —NH—C(═O)— and/or —C(═O)—NH—. Polyamides as a class of polymer are well known in the art and are commonly prepared via a condensation polymerization process whereby diamines are reacted with dicarboxylic acid (diacids) and refer to high molecular weight polymers having amide linkages along the molecular chain, including synthetic polyamides such as nylons. Such term encompasses both homo-polyamides and co-polyamides. It also specifically includes aliphatic polyamides or co-polyamides, aromatic polyamides or co-polyamides, and partially aromatic polyamides or co-polyamides, modifications thereof and blends thereof. The homo-polyamides are derived from the polymerization of a single type of monomer comprising both the chemical functions which are typical of polyamides, i.e., amino and acid groups, such monomers being typically lactams or amino acids, or from the polycondensation of two types of polyfunctional monomers, i.e. polyamines with polybasic acids. The multi-polyamides are derived from the copolymerization of precursor monomers of at least two (three or more) different polyamides. As an example in the preparation of the co-polyamides, two different lactams may be employed, or two types of polyamines and polyacids, or a lactam on one side and a polyamine and a polyacid on the other side. Exemplary polymers are polyamide 6, polyamide 6/9, polyamide 6/10, polyamide 6/12, polyamide 11, polyamide 12, polyamide 6/12, polyamide 6/66, polyamide 66/6/10, modifications thereof and blends thereof.

The term “polyolefin” refers to any thermoplastic polymer deriving from polymerisation of one or more olefins, such as ethylene, propylene and butene. The polymer may be a homopolymer, consisting of repeating units of one single olefin or a copolymer, consisting of a major proportion of one olefin and a minor proportion of one or more other olefins copolymerizable therewith. The term polyolefin specifically includes ethylene homo- and co-polymers, butene homo- and copolymers, propylene homo- and co-polymers, cycloolefins copolymers and the like. The term polyolefin also encompasses copolymers of ethylene comprising a major portion of ethylene and a minor portion of one or more alpha-olefins comonomers, preferably (C4-C10)-alpha-olefins, such as 1-butene, 1-hexene and/or 1-octene. These copolymers are generally referred to as “ethylene-alpha-olefin copolymers.” Depending on the composition in monomers and polymerization process employed, polymers with a different degree of branching and a different density can be obtained. Included in the term polyolefin are homopolymers of olefin, copolymers of olefin, copolymers of an olefin and a non olefinic comonomer (such as ester) etc. Specific examples include polyethylene homopolymer, polypropylene homopolymer, polybutene homopolymer, ethylene alpha olefin copolymer, propylene alpha olefin copolymer, butene alpha olefin copolymer, ionomer, ethylene ester copolymer, etc.

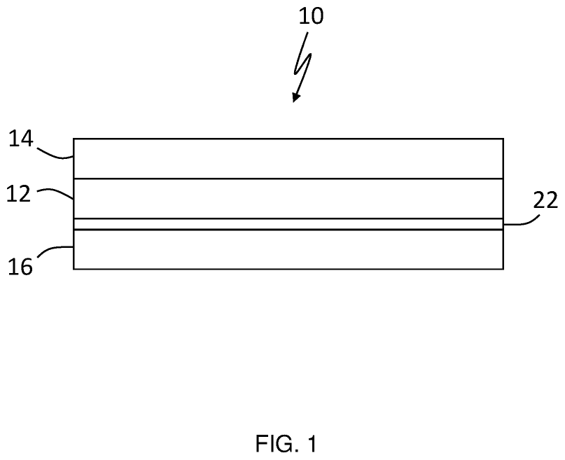

Referring to FIG. 1, an exemplary oriented film 10 comprises a polyolefin layer 12 positioned immediately between a first polyamide layer 14 and a second polyamide layer 16. Film 10 may be co-extruded and oriented monoaxially or biaxially. First polyamide layer 14 and a second polyamide layer 16 are preferred to be as outer layers for heat resistance. Polyolefin content is preferred to be the major content in the structure for recyclability and cost reasons. Film 10 may optionally contain a polymeric barrier layer 22, such as an ethylene vinyl alcohol (EVOH) layer as an oxygen barrier layer in the core structure of film 10, i.e., not as an outside layer.

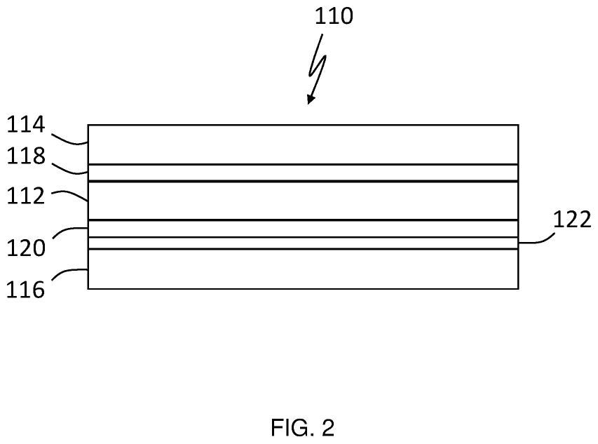

Referring to FIG. 2, another exemplary oriented film 110 may comprise a polyolefin layer 112 between a first polyamide layer 114 and a second polyamide layer 116 with a first tie resin layer 118 and a second tie resin layer 120 coupled between the polyolefin layer 112 and the first polyamide layer 114 and between the polyolefin layer 112 and the second polyamide layer 116, respectively. Film 110 may be co-extruded and oriented monoaxially or biaxially. First polyamide layer 114 and a second polyamide layer 116 are preferred to be as outer layers for heat resistance. Polyolefin content is preferred to be the major content in the structure for recyclability and cost reasons. Film 110 may optionally contain a polymeric barrier layer 122, such as an ethylene vinyl alcohol (EVOH) layer as an oxygen barrier layer in the core structure of film 110, i.e., not as an outside layer.

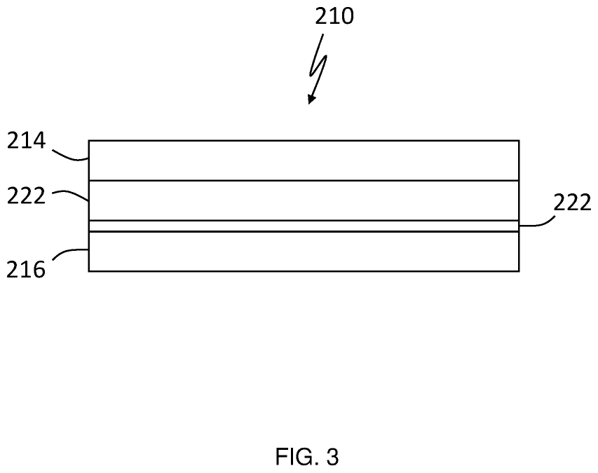

Referring to FIG. 3, a further exemplary oriented film 210 may include a combined polyolefin/polyamide layer 212 between a first polyamide layer 214 and a second polyamide layer 216. Film 210 may be co-extruded and oriented monoaxially or biaxially. First polyamide layer 214 and a second polyamide layer 216 are preferred to be as outer layers for heat resistance. Polyolefin content is preferred to be the major content in the structure for recyclability and cost reasons. Film 210 may optionally contain a polymeric barrier layer 222, such as an ethylene vinyl alcohol (EVOH) layer as an oxygen barrier layer in the core structure of film 210, i.e., not as an outside layer.

In any of the aspects described herein, additives to aid in the compatibility of the selected polyolefins and polyamides may be used. For example, functionalized polymers, coupling agents or impact modifiers may be included to improve binding of layers including maleic anhydride grafted polyolefins, acrylic acid/ethylene copolymers and ionomers made from them, metacrylic acid/ethylene copolymers and ionomers made from them, and polyacryclic acid grafted polyolefins.

### Example

Exemplary oriented films were produced on pilot equipment. Extrusion of the films was conducted on a conventional, off-the-shelf pilot scale multilayer cast extrusion line available from LabTech Inc. The extruded films were oriented using conventional, off-the-shelf pilot scale biaxial orientation equipment available from Brückner/Brueckner. After extrusion, samples were cut from the center of the extruded films. The oriented films were tested on laboratory scale film testing equipment for multiple properties.

A control film was used having the structure detailed. The control film was 135 microns and the final, oriented film thickness was 15 microns. Orientation in machine direction was three (3) times the original length, and the orientation in the cross direction was three (3) times the original length. The orientation temperature was 190° Celsius. The control film comprised five layers of ULTRAMID® B33 LN 01, a polyamide 6 polymer commercially available from BASF as set forth in Table 1 below:

TABLE 1
Control Film

| | Layer ratio (%) | | % in |
|---|---|---|---|
| | by volume | Resin 1 | the blend |
| Layer A | 13 | Ultramid B33 LN 01 | 100% |
| Layer B | 14.5 | Ultramid B33 LN 01 | 100% |
| Layer C | 45 | Ultramid B33 LN 01 | 100% |
| Layer B | 14.5 | Ultramid B33 LN 01 | 100% |
| Layer A | 13 | Ultramid B33 LN 01 | 100% |

The composition of an exemplary oriented film according to the present disclosure is seen in Table 2 below. The extruded film thickness was 180 microns and the final oriented film thickness was 15 microns. Orientation in machine direction is 4 times the original length, Orientation in cross direction is 3 times the original length. The orientation temperature is 126 Celsius. The layers of exemplary film were formed from ULTRAMID® B33 LN 01, PLEXAR® PX 5125, a polyethylene based maleic anhydride grafted tie resin produced and sold by Lyondel Basel, and MARLEX® D174 a metallocene catalyzed liner low density polyethylene resin produced and sold by Chevron Philips Chemical.

TABLE 2
Exemplary Oriented Film

| | Layer ratio (%) | | % in |
|---|---|---|---|
| | by volume | Resin 1 | the blend |
| polyamide layer | 25 | Ultramid B33 LN 01 | 100% |
| tie layer | 10 | Plexar PX 5125 | 100% |
| polyolefin layer | 30 | Marlex D174 | 100% |
| tie layer | 10 | Plexar PX 5125 | 100% |
| polyamide layer | 25 | Ultramid B33 LN 01 | 100% |

The ratio of each polyamide layer may be between 1 and 50 percent, including between 5 and 20 percent, and between 10 and 15 percent. The ratio of each tie layer may be between 1 and 20 percent, including between 5 and 15 percent. The ratio of the polyolefin layer may be between 1 and 90 percent, including between 10 and 50 percent and between 20 and 40 percent. The layer ratio does not include any compatibilizer additives that may be included to assist with binding of the various layers. In one aspect, the preferred ratio polyamides content relative to polyolefin content is 50 percent or less to ensure recyclability of the final film.

The characteristics and performance of the exemplary film according to the present disclosure was compared against the control and an off-the-shelf biaxially oriented polyethylene film (25HD200 available from Jindal) used for recyclable packaging applications. As seen in Table 3 below, the exemplary film exhibits properties that are satisfactory for packaging applications despite slightly lower puncture and modulus compared to the control or the commercial oriented polyethylene film:

TABLE 3
Results

| | Puncture | Surface layer | | MD Tensile | MD Tensile |
|---|---|---|---|---|---|
| | force | temperature | Modulus | Strength | Elongation |
| | (Newton) | resistance | (GPa) per | (MPa) per | (%) per |
| | per ASTM | (Celsius) per | ASTM | ASTM | ASTM |
| | F1306-90 | internal method | D882-09 | D882-09 | D882-09 |
| Control | 26 | Below 200 | 2.1 | 180 | 69 |
| Commercial oriented | 15.5 | Below 140 | 1.49 | 119 | 131 |
| polyethylene film, | | | | | |
| 25HD200 | | | | | |
| Inventive | 11 | Below 200 | 0.9 | 83-87 | 60 |

The exemplary film shows similar MD orientation to the control, which is important for machinability. On the other hand, the commercial polyethylene film exhibits much higher MD elongation. The commercial polyethylene film surface temperature resistance was checked by a heat sealer and visual observation was made of the surface sticking to the seal jaws. By contrast, the exemplary film displayed surface heat resistance that was similar to the control and its heat resistance was significantly higher than the commercial polyethylene film.

The exemplary film has improved recyclability such that the use of the exemplary films in products will allow for recycling in existing polyolefin recycling streams due to its lower polyamide content that is a result of the low overall polyamide content, particularly in comparison to the control film. For example, current industry and government guidelines on recyclable packaging require that the composition must be recyclable, or compatible with recycling processes, currently in use for polyolefins such as polyethylene based items. Specific standards include ISO 14021:2016 Section 7.8.1.1 as well as design guidance promulgated by the American Chemistry Council, the National Association for PET Container Resources, and the Association of Plastic Recyclers.

As is known in the art, the exemplary film—and the control and commercial polyethylene films—are typically laminated to a polyolefin based sealant film for us in connection with food packaging applications. As a result, the low polyamide content, higher heat resistance, and good machinability of the exemplary films are critical characteristics for the use of the exemplary films in packaging applications and where recyclability is important.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms. Unless otherwise defined, all technical and scientific terms used herein have the same meaning as commonly understood by one of ordinary skill in the art. The materials, methods, and examples disclosed herein are illustrative only and not intended to be limiting.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “first”, “second”, “third”, and the like, as used herein, do not denote any order, quantity, or importance, but rather are used to distinguish one element from another.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, the aldehyde group —CHO is attached through the carbon of the carbonyl group.

The present disclosure refers to “polymers,” “oligomers”, and “compounds.” A polymer is a large molecule composed of multiple repeating units chained together, the repeating units being derived from a monomer. One characteristic of a polymer is that different molecules of a polymer will have different lengths, and a polymer is described as having a molecular weight that is based on the average value of the chains (e.g. weight average or number average molecular weight). The art also distinguishes between an “oligomer” and a “polymer”, with an oligomer having only a few repeating units, while a polymer has many repeating units. For purposes of this disclosure, the term “oligomer” refers to such molecules having a weight average molecular weight of less than 15,000, and the term “polymer” refers to molecules having a weight average molecular weight of 15,000 of more, as measured by GPC using polycarbonate molecular weight standards. In contrast, for a compound, all molecules will have the same molecular weight. Compared to a polymer, a compound is a small molecule.

The term “homopolymer” as used herein refers to a polymer derived from only one structural unit or monomeric species.

The term “copolymer” refers to a polymer derived from two or more structural unit or monomeric species, as opposed to a homopolymer, which is derived from only one structural unit or monomer.

The term “Melt Volume Rate” (MVR) or “Melt Flow Rate (MFR)” refers to the flow rate of a polymer in a melt phase as determined using the method of ASTM D1238. The MVR of a molten polymer is measured by determining the amount of polymer that flows through a capillary of a specific temperature over a specified time using standard weights at a fixed temperature. MVR is expressed in cubic centimeter per 10 minutes, and MFR is expressed in grams per 10 minutes. The higher the MVR or MFR value of a polymer at a specific temperature, the greater the flow of that polymer at that specific temperature.

It should also be understood that, unless clearly indicated to the contrary, in any methods claimed herein that include more than one step or act, the order of the steps or acts of the method is not necessarily limited to the order in which the steps or acts of the method are recited.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

Additionally, for the recitations of numeric amounts and ranges herein, terms such as “less than about X” and “at least about X” should be interpreted as also explicitly disclosing “about X”. For example, “less than about 3 g/10 min.” expressly contemplates “about 3 g/10 min.”, and “at least 60 g/10 min.” expressly contemplates “about 60 g/10 min.”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

What is claimed is:

1. An oriented packaging film, comprising:
a first layer comprised of a first polyamide;
a second layer comprised of a second polyamide; and
a third layer comprised of a polyolefin and positioned between the first layer and the second layer.

2. The oriented packaging film of claim 1, further comprising a barrier layer positioned between the third layer and at least one of the first layer and the second layer.

3. The oriented packaging film of claim 2, wherein the barrier layer is formed from ethylene vinyl alcohol.

4. The oriented packaging film of claim 1, further comprising a first tie resin layer positioned between the third layer and one of the first layer and the second layer.

5. The oriented packaging film of claim 4, further comprising a second tie resin layer positioned between the third layer and the other of the first layer and the second layer.

6. The oriented packaging film of claim 5, further comprising a barrier layer positioned between the third layer and at least one of the first layer and the second layer.

7. The oriented packaging film of claim 1, wherein the third layer is additionally comprised of a polyamide.

8. The oriented packaging film of claim 1, wherein the third layer is additionally comprised of a compatibilizer.

9. The oriented packaging film of claim 1, wherein the first polyamide and the second polyamide comprise fifty percent or less of the oriented packaging film by volume.

10. The oriented packaging film of claim 1, wherein the first polyamide and the second polyamide are each present in an amount of between one percent and 50 percent of the oriented packaging film by volume.

11. The oriented packaging film of claim 10, wherein the polyolefin is present in an amount between 1 and 60 percent of the oriented packaging film by volume.

12. The oriented packaging film of claim 1, wherein the first polyamide and the second polyamide are each present in an amount of between 5 percent and 20 percent of the oriented packaging film by volume.

13. The oriented packaging film of claim 12, wherein the polyolefin is present in an amount between 10 and 50 percent of the oriented packaging film by volume.

14. The oriented packaging film of claim 1, wherein the oriented packaging film is oriented monoaxially.

15. The oriented packaging film of claim 1, wherein the oriented packaging film is oriented according to an orientation selected from the group consisting of monoaxially and biaxially.

16. A method of making a packaging film, comprising the step of coextruding a first layer comprised of a first polyamide, a second layer comprised of a second polyamide, and a third layer comprised of a polyolefin so that the third layer is positioned between the first layer and the second layer.

17. The method of claim 16, wherein the step of coextruding includes coextruding a barrier layer positioned between the third layer and at least one of the first layer and the second layer.

18. The method of claim 17, wherein the step of coextruding includes coextruding a first tie resin layer positioned between the third layer and at least one of the first layer and the second layer.

19. The method of claim 16, wherein the first polyamide and the second polyamide comprise fifty percent or less of the oriented packaging film by volume.

20. The method of claim 19, wherein the oriented packaging film is recyclable in a polyethylene recycling stream.
